(19) United States
(12) Patent Application Publication
(10) Pub. No.: US 2026/0116309 A1
(43) Pub. Date: Apr. 30, 2026

(54) Truck Rack

(71) Applicant: Ricardo Santiago Ignarra, La Habra, CA (US)

(72) Inventor: Ricardo Santiago Ignarra, La Habra, CA (US)

(21) Appl. No.: 19/287,561

(22) Filed: Jul. 31, 2025

Related U.S. Application Data
(60) Provisional application No. 63/677,807, filed on Jul. 31, 2024.

(51) Int. Cl. B60R 9/045; B60R 9/048

(52) U.S. Cl. CPC B60R 9/045; B60R 9/048

(57) ABSTRACT

A robust truck rack having continuously adjustable uprights and crossmembers is disclosed. A telescoping upright is formed by an inner tubular member sliding within a larger outer tubular member. The upright is locked in place using two differing locking mechanisms. A first mechanism relies on a generally rectangular slide plate positioned within a T-shaped channel formed on the inner tubular member which is then clamped in place such that the inner and outer tubular members are held in place via a frictional coupling. The second locking mechanism affixes a projecting stop plate onto the inner tubular member forming an affirmative stop preventing the inner tubular member from moving beyond the stop point. A continuously adjustable crossmember-siderail coupling mechanism is disclosed.

### RELATED APPLICATION INFORMATION

The present application claims priority under 35 U.S.C. Section 119(e) to U.S. Provisional Patent Application Ser. No. 63/677,807 filed Jul. 31, 2024 entitled “Truck Rack” the disclosure of which is incorporated herein by reference in its entirety.

### BACKGROUND OF THE INVENTION

### 1. Field of the Invention

The present invention relates in general to truck racks mounted in a bed of a pickup truck. More particularly, the invention is directed to robust truck racks having continuously adjustable truck rack uprights and rack structures.

### 2. Description of the Related Art

A truck rack is a structural framework mounted in a bed of a truck and is often used for hauling construction equipment, tools, and ladders, as well as carrying items for recreational use such as bicycles and kayaks. Truck racks must be versatile and readily adjustable in terms of configuration and dimensions to accommodate differing sizes of truck beds as well as cargo which needs to be stowed onto the truck rack. Many conventional truck racks employ rails with multiple, indexed holes which are bolted together to assemble the truck rack. As such, the overall dimensions and configuration of the truck rack are not continuously adjustable which may limit the ability to customize a truck rack for a particular truck or application. While some truck rack designs offer continuously adjustable features, these designs may not support the weight of cargo during normal operation.

Hence, a need exists to provide a robust truck rack having continuous adjustments which may be tailored for specific applications.

### SUMMARY OF THE INVENTION

In a first aspect, a truck rack for a truck bed is disclosed. The truck rack comprises a crossmember having a crossmember T-shaped channel formed on the outer surface thereof extending longitudinally along the crossmember, and a pair of telescoping uprights extending upward from opposite sides of the truck bed supporting the crossmember, each telescoping upright comprising an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member. Each telescoping upright further comprises a locking mechanism for releasably adjusting and locking the height of each telescoping upright.

Each locking mechanism comprises a friction coupling assembly and a positive stop assembly. The friction coupling assembly comprises a friction coupling slide plate configured to slide and engage within the first T-shaped channel of the inner tubular member, one or more friction coupling fasteners emerging from the friction coupling slide plate away from the inner tubular member and extending through the outer tubular member, wherein the friction coupling assembly locks a position of the inner tubular member with respect to the outer tubular member.

The positive stop assembly comprises a positive stop slide plate configured to slide and engage within the second T-shaped channel of the inner tubular member, one or more positive stop fasteners emerging from the positive stop slide plate away from the inner tubular member, and a positive stop plate placed on an outer surface of the inner tubular member and engaging with the one or more positive stop fasteners, the positive stop fasteners releasably positioning the positive stop plate on the inner tubular member to provide an affirmative stop preventing further movement of the inner tubular member into the outer tubular member.

In a first preferred embodiment, the truck rack for a truck bed further comprises an over cab coupling mechanism comprising an over cab slide plate configured to slide and engage within a crossmember T-shaped channel of the crossmember, one or more over cab fasteners emerging from the over cab slide plate away from the cross member, a base plate countered to at least partially surround and slide upon the crossmember, the base plate engaging with the one or more over cab fasteners, the over cab coupling mechanism adopted to lock a position of the over cab mechanism on the crossmember, and an open sleeve formed on the base plate, the open sleeve adapted for receiving a side rail.

One or more of the friction coupling slide plate, the positive stop slide plate, and the over cab slide plate are preferably textured. One or more over cab fasteners preferably comprise one or more bolts having a knurled knob adopted for hand tightening such that the over cab slide plate is locked in position. The friction coupling assembly preferably further comprises a friction coupling lock plate positioned on an outer surface of the outer tubular member and engaging with the one or more friction coupling fasteners.

The truck rack preferably further comprises a sleeve axially positioned between the inner tubular member and the outer tubular member, the sleeve aligning and centering the inner tubular member within the outer tubular member, the sleeve allowing longitudinal movement of the inner tubular member within the outer tubular member. Each telescoping upright preferably supports at least 200 pounds of weight. The inner tubular member and the outer tubular members are preferably formed in extruded aluminum. The positive stop plate preferably further comprises a tie down.

In a second aspect, a truck rack for a truck bed is disclosed. The truck rack comprises a pair of telescoping uprights extending upward from opposite sides of the truck bed supporting a crossmember, each telescoping upright comprising an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, each telescoping upright further comprising a locking mechanism for releasably adjusting and locking the height of each telescoping upright. Each locking mechanism comprises a friction coupling assembly and a positive stop assembly. The friction coupling assembly comprises a friction coupling slide plate configured to slide and engage within the first T-shaped channel of the inner tubular member, the friction coupling slide plate attached to a fixed position on the outer tubular member, a fastener adopted urge the friction coupling slide plate against the first T-shaped channel creating a frictional engagement which locks a position of the friction coupling slide plate in the first T-shaped channel, thereby locking a position of the inner tubular member with respect to the outer tubular member.

The positive stop assembly comprises a positive stop slide plate configured to slide and engage within the second T-shaped channel of the inner tubular member, a positive stop plate placed on an outer surface of the inner tubular member, the positive stop plate attached to the positive stop slide plate, a positive stop coupling mechanism adopted urge the positive stop slide plate against the second T-shaped channel creating a frictional engagement which locks a position of the positive stop slide plate in the second T-shaped channel. The positive stop assembly locks a position of the positive stop plate on the inner tubular member creating an affirmative stop preventing the further movement of the outer tubular member with respect to the inner tubular member.

In a second preferred embodiment, the truck rack further comprises an over cab coupling assembly comprising an over cab slide plate configured to slide and engage within a crossmember T-shaped channel of a crossmember, a base plate countered to at least partially surround and slide longitudinally along the crossmember, the base plate attached to the over cab slide plate, an open sleeve formed on the base plate, the open sleeve adapted for receiving a side rail, and a friction coupling mechanism adopted to urge the over cab slide plate against the first a crossmember T-shaped channel creating a frictional engagement which locks a position of the over cab slide plate in the crossmember T-shaped channel, thereby locking a position of the base plate with respect to the crossmember.

The friction coupling mechanism preferably comprises a bolt having a knurled knob adopted for hand tightening such that the over cab slide plate is locked in position within a crossmember T-shaped channel of a crossmember. One or mor of the friction coupling slide plate, the positive stop slide plate, and the over cab slide plate are preferably textured. The truck rack preferably further comprises a sleeve axially positioned between the inner tubular member and the outer tubular member, the sleeve aligning and centering the inner tubular member within the outer tubular member, the sleeve allowing longitudinal movement of the inner tubular member within the outer tubular member. The inner tubular member and the outer tubular members are preferably formed in extruded aluminum.

In a third aspect, a truck rack for a truck bed is disclosed. The truck rack comprises a front crossmember positioned near a front side of a truck bed, the front crossmember having a front T-shaped channel extending along the length of the front crossmember, a back crossmember positioned near a back side of a truck bed, the back crossmember having a back T-shaped channel extending along the length of back crossmember, an over cab assembly comprising a left side rail and a right side rail, the over cab assembly supported by the front and back crossmembers, a first pair of telescoping uprights extending upward from opposite sides of the front of the truck bed supporting the front crossmember, and a second pair of telescoping uprights extending upward from opposite side of the back of the truck bed supporting the back crossmember.

Each telescoping upright comprises an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, the outer tubular member comprising two friction coupling assembly mounting through holes. Each telescoping upright further comprises a locking mechanism for releasably securing and varying the height of each telescoping upright over a continuous range.

Each locking mechanism comprises a friction coupling assembly comprising a friction coupling slide plate configured to slide and engage within the first T-shaped channel of the inner tubular member, two friction coupling threaded rods emerging from the friction coupling slide plate away from the inner tubular member and extending through the two friction coupling assembly mounting through holes of the outer tubular member, a friction coupling lock plate positioned on an outer surface of the outer tubular member and engaging with the two friction coupling threaded rods, and two friction coupling threaded nuts engaging with the two friction coupling threaded rods, wherein tightening the friction coupling threaded nuts locks a position of the inner tubular member with respect to the outer tubular member.

The positive stop assembly comprises a positive stop slide plate configured to slide and engage within the second T-shaped channel of the inner tubular member, two positive stop threaded rods emerging from the positive stop slide plate away from the inner tubular member, and a positive stop plate placed on an outer surface of the inner tubular member and engaging with the two positive stop threaded rods, and two positive stop threaded nuts engaging with the positive stop threaded rods, wherein tightening the positive stop threaded nuts locks a position of the positive stop plate on the inner tubular and provides an affirmative stop preventing further movement of the inner tubular member into the outer tubular member.

In a third preferred embodiment, the truck rack further comprises four over cab coupling mechanisms adopted for releasably securing the over cab assembly to the front and back crossmembers, each over cab coupling mechanism comprising an over cab slide plate configured to slide and engage within the crossmember T-shaped channel of the crossmember, one over cab threaded rod emerging from the over cab slide plate away from the cross member, a base plate countered to at least partially surround a and slide upon the crossmember, the base plate having an over cab through hole to receive with the over cab threaded rod, an over cab threaded nut engaging with the over cab threaded rod, wherein tightening the over cab threaded nut locks the position of the over cab mechanism on the crossmember, and an open sleeve formed on the base plate, the open sleeve adapted for receiving a side rail.

One or more of the friction coupling slide plate, the positive stop slide plate, and the over cab slide plate are preferably textured to increase the frictional engagement. The positive stop plate preferably further comprises a tie down. The inner tubular member and the outer tubular members are preferably formed in extruded aluminum.

In a fourth aspect, a truck rack for a truck bed is disclosed. The truck rack comprises a contractor rack comprising and an overland rack assembly. Th contractor rack comprising a front crossmember positioned near a front side of a truck bed, the front crossmember having a front T-shaped channel extending along the length of the front crossmember, a back crossmember positioned near a back side of a truck bed, the back crossmember having a back T-shaped channel extending along the length of back crossmember, a first pair of telescoping uprights extending upward from opposite sides of the front of the truck bed supporting the front crossmember, and a second pair of telescoping uprights extending upward from opposite side of the back of the truck bed supporting the back crossmember. The overland rack assembly comprises a lower pair of side rails, and four over cab coupling mechanisms connecting the lower pair of side rails of the overland rack assembly to the front and back crossmembers of the contractor rack.

Each telescoping upright comprises an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, the outer tubular member comprising two friction coupling assembly mounting through holes. Each telescoping upright further comprises a locking mechanism for releasably securing and varying the height of each telescoping upright over a continuous range.

Each locking mechanism comprises a friction coupling assembly and a positive stop assembly. The friction coupling assembly comprises a friction coupling slide plate configured to slide and engage within the first T-shaped channel of the inner tubular member, two friction coupling threaded rods emerging from the friction coupling slide plate away from the inner tubular member and extending through the two friction coupling assembly mounting through holes of the outer tubular member, a friction coupling lock plate positioned on an outer surface of the outer tubular member and engaging with the two friction coupling threaded rods, and two friction coupling threaded nuts engaging with the two friction coupling threaded rods, wherein tightening the friction coupling threaded nuts locks a position of the inner tubular member with respect to the outer tubular member.

The positive stop assembly comprises a positive stop slide plate configured to slide and engage within the second T-shaped channel of the inner tubular member, two positive stop threaded rods emerging from the positive stop slide plate away from the inner tubular member, a positive stop plate placed on an outer surface of the inner tubular member and engaging with the two positive stop threaded rods, and two positive stop threaded nuts engaging with the positive stop threaded rods, wherein tightening the positive stop threaded nuts locks a position of the positive stop plate on the inner tubular and provides an affirmative stop preventing further movement of the inner tubular member into the outer tubular member.

In a fourth preferred embodiment, each over cab coupling mechanism comprises an over cab slide plate configured to slide and engage within a crossmember T-shaped channel of a crossmember, one over cab threaded rod emerging from the over cab slide plate away from the crossmember, a base plate countered to at least partially surround a and slide upon the crossmember, the base plate having an over cab through hole to receive with the over cab threaded rod, an over cab threaded nut engaging with the over cab threaded rod, wherein tightening the over cab threaded nut locks the position of the over cab mechanism on the crossmember, and an open sleeve formed on the base plate, the open sleeve adapted for receiving a side rail. The overland rack assembly is preferably configured to remain as a complete, intact assembly once assembled. The overland rack assembly is preferably releasably detachable from the contractor rack.

These and other features and advantages of the invention will become more apparent with a description of preferred embodiments in reference to the associated drawings.

### DESCRIPTION OF THE DRAWINGS

FIG. 1 is a perspective view of a smaller pickup truck with a truck rack in the bed.

FIG. 2 is a perspective view of a larger pickup truck with a truck rack in the bed.

FIG. 3 is a perspective view of a truck rack in one or more embodiments.

FIG. 4 is a side view of a truck rack in one or more embodiments.

FIG. 5 is a front view of a truck rack in one or more embodiments.

FIG. 6 is a cross-sectional view of the mounting mechanism used to secure each upright to the bed of the truck.

FIG. 7 is a perspective view of the locking mechanism of the uprights showing the friction coupling assembly.

FIG. 8 is a perspective view of the locking mechanism of the uprights showing the positive stop assembly.

FIG. 9 is a cross-sectional view of the profile of the inner and outer tubular members.

FIG. 10 is a cross-sectional view of a partially disassembled friction coupling assembly and the positive stop assembly.

FIG. 11 is a perspective view of a partially disassembled positive stop assembly.

FIG. 12 perspective view of a partially disassembled friction coupling assembly and the positive stop assembly.

FIG. 13 is a perspective view of a sleeve.

FIG. 14 is a perspective view of a disassembled inner tubular member and outer tubular member.

FIG. 15 is a perspective view of the frictional coupling assembly in an embodiment.

FIG. 16 is a perspective view of an endcap on an inner tubular member.

FIG. 17 is a side view of an upright employing multiple indexed holes on the inner tubular member which is secured via bolt through the outer tubular member.

FIG. 18 is a perspective view of an over cab coupling mechanism.

FIG. 19 is a perspective view of an over cab coupling mechanism showing the slide plate.

FIG. 20 is a perspective view of an over cab coupling mechanism showing the open sleeve for receiving a side rail.

### DETAILED DESCRIPTION OF THE PREFERRED EMBODIMENTS

Many truck owners purchase aftermarket truck racks for their vehicles. Truck racks must be customizable not only for use in differing sized trucks, but also for their cargo-carrying applications. For example, truck racks should fit both larger and smaller truck racks where larger pickup trucks may have a bed length of 8 feet, while small pickup trucks may have a bed length of 4½, 5, or 6 feet. Likewise, truck racks should also accommodate differing cargo loads for users. Tradesmen and contractors may rely on truck racks to carry heavier loads such as ladders, construction supplies, and equipment to their job sites, while outdoor enthusiasts may use truck racks to transport longer and bulkier equipment such as kayaks, surf boards, and bikes. Different truck rack configurations are often referred to as either as a “contractor rack” when used by tradesmen who need additional carrying capacity, or as an “overland rack” when used for outdoor or camping purposes.

Many truck rack manufacturers address this issue of customization by adapting modular designs which often employ components having multiple, indexed holes along the length of uprights and crossmembers (or “cross bars”) which can then be bolted together to create a truck rack with a desired size or configuration. This approach does offer some flexibility for obtaining the desired dimensions for a truck rack, but, ultimately, the truck rack dimensions are not continuously adjustable and are ultimately established by the separation of the holes in the uprights and crossmembers for example. Moreover, reconfiguring a truck rack for another application may require disassembly of the rack by manually unbolting the uprights and crossmembers to rearrange the components to a new configuration.

While some effort has been made to offer trucks racks having continuously adjustable features, these designs may not adequately support the weight of cargo during normal operation. For example, some commercially available, continuously adjustable truck racks may exhibit “slippage” of the uprights (i.e., the uprights being unable to support cargo at a desired height) when the cargo weight exceeds 350 pounds distributed over the four uprights when the vehicle is driven over uneven terrain, rendering the use of these truck racks impractical.

In an embodiment, a robust truck rack having continuously adjustable components such as uprights and crossmembers is contemplated. An upright (or “pedestal”) is formed by an inner tubular member sliding within a larger outer tubular member, which, much like the operation of a telescope, will shorten or lengthen continuously as required. The inner tubular member has two T-shaped channels (or “T-tracks”) which allow components to be mounted onto the inner tubular member and clamped into place.

The inner tubular member is locked in place to the outer tubular member using two differing locking mechanisms. The first locking mechanism, referred to herein as a “friction coupling assembly,” relies on a generally rectangular slide plate positioned within a T-shaped channel formed on the inner tubular member which is then clamped in place. The outer tubular member is effectively bolted to this slide plate so that the inner and outer tubule members are held in place via frictional coupling.

The second locking mechanism, referred to herein as a “positive stop assembly,” also employs another generally rectangular slide plate clamped in place in a second T-shaped channel formed on inner tubular member which affixes a projecting stop plate onto the inner tubular member. This projecting stop plate interferes with the downward movement of the inner tubular member, thus forming an affirmative stop preventing the inner tubular member from moving beyond the stop point. These two locking mechanisms may support over 800 pounds of cargo weight evenly distributed over the four uprights.

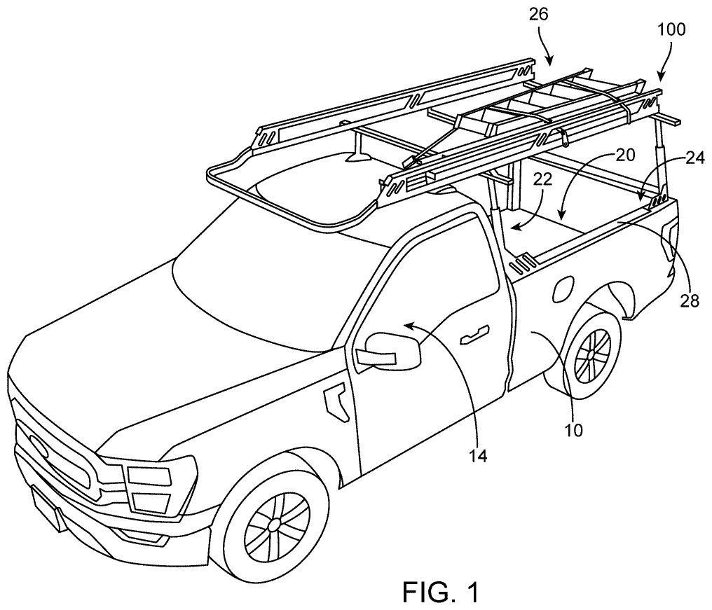

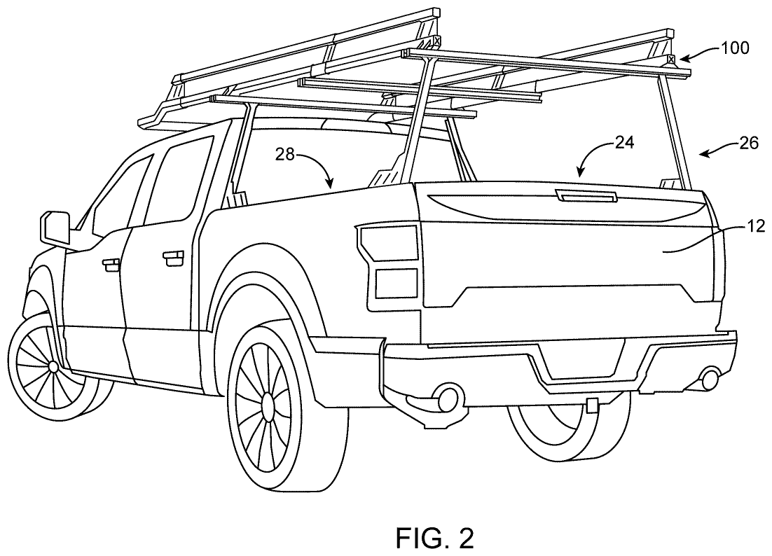

FIGS. 1 and 2 are perspective views of a smaller pickup truck 10 and a larger pickup truck 12 having a full-size, 8 foot truck bed, respectively, with a truck rack 100 in the bed 20 of the trucks 10 and 12. Locational points of reference include the front of the bed 22 near the cabin 14 (or “cab”), the back or rear of the bed 24 near the rear bumper, the right side 28 of the bed 20 (the right side of the truck 10 as viewed from the front of the truck) located on the driver's side, and the left side 26 of the bed 20 located on the passenger's side of the truck 10 and 12.

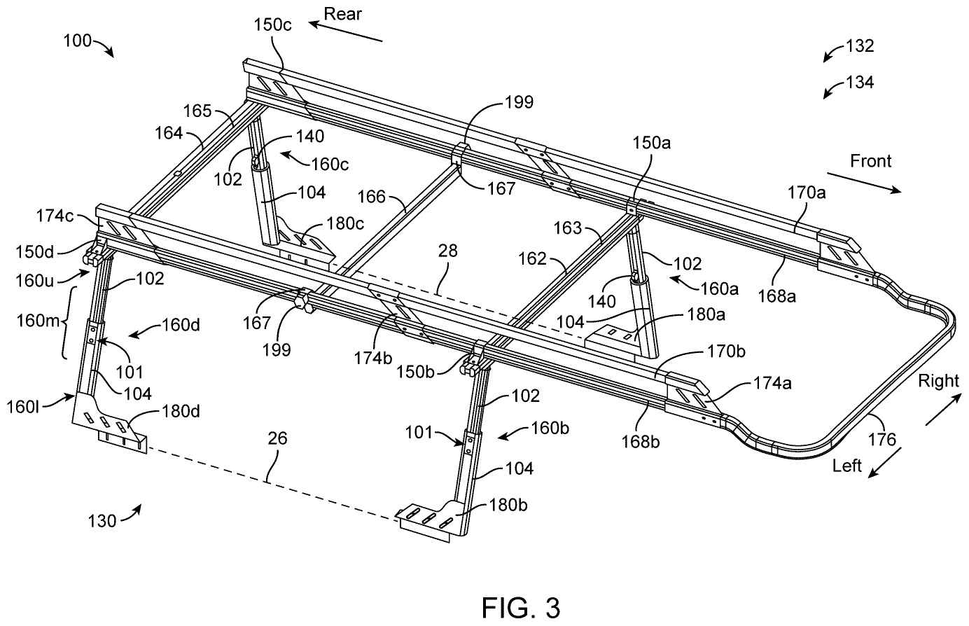

FIG. 3 is a perspective view of a presently preferred truck rack 100 showing its innovative construction and functionality, along with its new and unique design that provides it with an overall attractive appearance. As shown, the presently preferred truck rack 100 is comprised of four uprights 160a, 160b, 160c, & 160d (referred to collectively as 160abcd) that extend upward from the bed 20 of the truck 10, a forward pair of uprights 160a and 160b supports a first forward crossmember 162 (i.e., “front crossmember”) and a rearward pair of uprights 160c and 160d support a second back crossmember 164 (i.e., “back crossmember” 164). A lower pair of side rails 168a and 168b are then supported on top of the first 162 and second crossmembers 164. The lower side rails 168ab being comprised of extruded aluminum with outer profile dimensions of about 1½″ wide×2½″ tall. An upper pair of side rails 170a and 170b having a generally square-shaped profile with outer profile dimensions about 1½″×1½″ are connected to the lower pair of side rails 168a and 168b by support members 174abcd (i.e., 174a, 174b, 174c, and 174d) that themselves are formed from extruded aluminum. The support members 174abcd have profiles that slidably receive the upper and lower side rails 170ab and 168ab. A third, inner crossmember 166 may also be attached to and hung from the lower side rails 170ab, as shown, with a knurled knob 199 that allows it to be loosened and positioned more fore or more aft as desired.

In the configuration shown, because the crossmembers 162 and 164 are located below the lower side rails 168a and 168b, it also features a drop hoop 176 arrangement that extends forward, over the cab 14 (See FIG. 1), and drops downward to provide an upper support surface that is in the same plane as the upper surfaces of crossmembers 162 and 164 over the bed 20 of the truck 10. The bottom surface of the lowest forward portion of the drop hoop 176 is about 2½″ above the truck cab 14. The applicant has aesthetically designed the hoop 176 so that it is a single continuous loop that drops down over the cab 14, as required, in a functional and aesthetically pleasing manner.

In an embodiment, the truck rack 100 comprises four telescoping uprights, 160abcd (i.e., 160a, 160b, 160c, and 160d) each having a lower portion 160l, a middle portion 160m, and an upper portion 160u. Each lower portion 160l of the telescoping uprights 160abcd is connected to a corresponding truck mount 180abcd (i.e., upright 160a is connected to mount 180a, upright 160b is connected to mount 180b, upright 160c is connected to mount 180c, and upright 160d is connected to mount 180d). The front pair of uprights 160a and 160b extend upward from opposite sides 26 and 28 (i.e., the left side of the bed 26 and the right side of the bed 28) of the front 22 of the truck bed 10 and the upper portion 160u supports the front crossmember 162. The back pair of uprights 160c and 160d extend upward from opposite sides 26 and 28 (i.e., the left side of the bed 26 and the right side of the bed 28) of the back 24 of the truck bed 10 and the upper portion 160u of 160c and 160d supports the back crossmember 164.

On the right side 28 of the truck bed 20, a lower side rail 168a is supported by front crossmember 162 and back crossmember 164. On the left side 26 of the truck bed 20, a lower side rail 168b is supported by front crossmember 162 and back crossmember 164. The lower side rails 168a and 168b are coupled to the front crossmember 162 and back crossmember 164 with four over cab coupling mechanisms 150a, 150b, 150c, and 150d.

In other words, a truck rack 100 comprises a front crossmember 162 positioned near a front side 22 of a truck bed 20, the front crossmember 162 having a front T-shaped channel 163 extending along the length of the front crossmember 162 and a back crossmember 164 positioned near a back side 24 of a truck bed 20, the back crossmember 164 having a back T-shaped channel 165 extending along the length of back crossmember 164. The truck rack 100 further comprises an over cab assembly 132, where the over cab assembly comprises a left side rail 168b and a right side rail 168a, the over cab assembly 134 supported by the front and back crossmembers 162 and 164. The truck rack 100 further comprises a first pair of telescoping uprights 160a and 160b extending upward from opposite sides 26 and 28 of the front 22 of the truck bed 20 supporting the front crossmember 162 and a second pair of telescoping uprights 160c and 160d extending upward from opposite sides 26 and 28 of the back 24 of the truck bed 20 supporting the back crossmembers 160c and 160d.

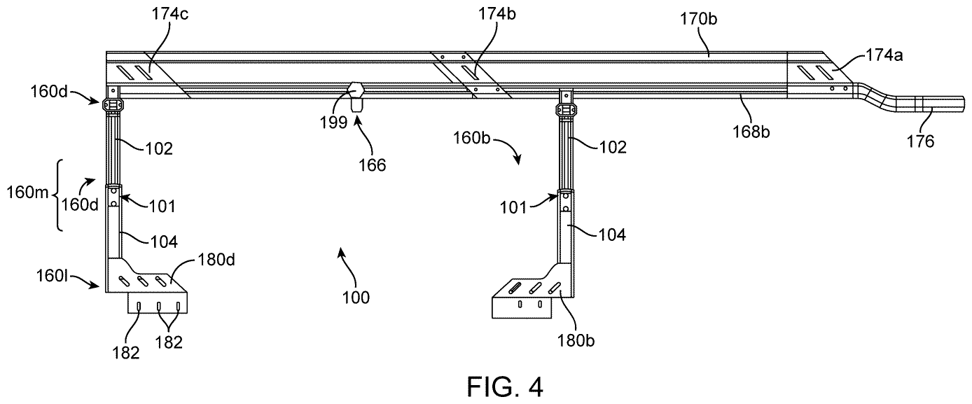

FIG. 4 is a side view of a truck rack 100 in one or more embodiments. The uprights 160abcd comprise an outer tubular member 104 and an inner tubular member 102 where the outer tubular member 104 has an internal cavity 105 (see FIG. 14) adapted to slidably receive the inner tubular member 102. The uprights 160abcd have an upper portion 160u, a middle portion 160m, and a lower portion 160l. The middle portion 160m of the uprights 160abcd is adapted to telescope longitudinally to vary an overall height of the pair of the telescoping uprights 160abcd over a continuous range. That is, the overall height of the uprights 160abcd can be continuously varied or adjusted smoothly without fixed, discrete steps between the minimum and maximum limits. The upper portion of the uprights 160u is connected to and support the front crossmember 162 and the back crossmember 164. The lower portion of the uprights 160l a connected to the mounts 180abcd (i.e., 180a, 180b, 180c, and 180d).

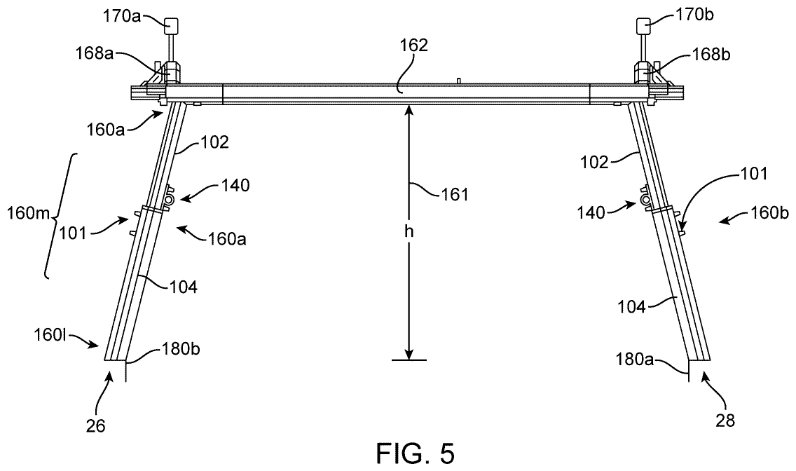

FIG. 5 is a front view of a truck rack 100 showing in one or more embodiments. A crossmember 162 is supported by a pair of telescoping uprights 160a and 160b extending upward from opposite sides (i.e., left side 26 and right side 28) of the truck bed 10. A pair of uprights 160a and 160b supporting a crossmember 162 may be referred to as a “goalpost.” Each telescoping upright 160a and 160b further comprising a locking mechanism 101 for releasably adjusting and locking the height “h” 161 of each telescoping upright 160a and 160b.

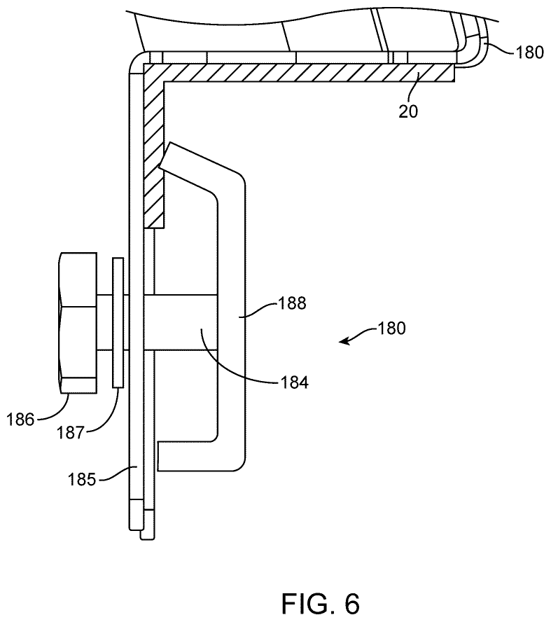

FIG. 6 is a cross-sectional view of the presently preferred mounting mechanism 180 used to secure each upright 160abcd to the bed 20 of the truck 10. As shown, one or more adjustment knobs 186 (with a washer 187) with a threaded shaft 184 is used to pull a clamping member 188 back toward the mounting base 108 of each upright 160abcd. As a result, the bed of the truck 20 is securely squeezed between the vertical wall 185 of the mounting base 180 and the clamping member 188.

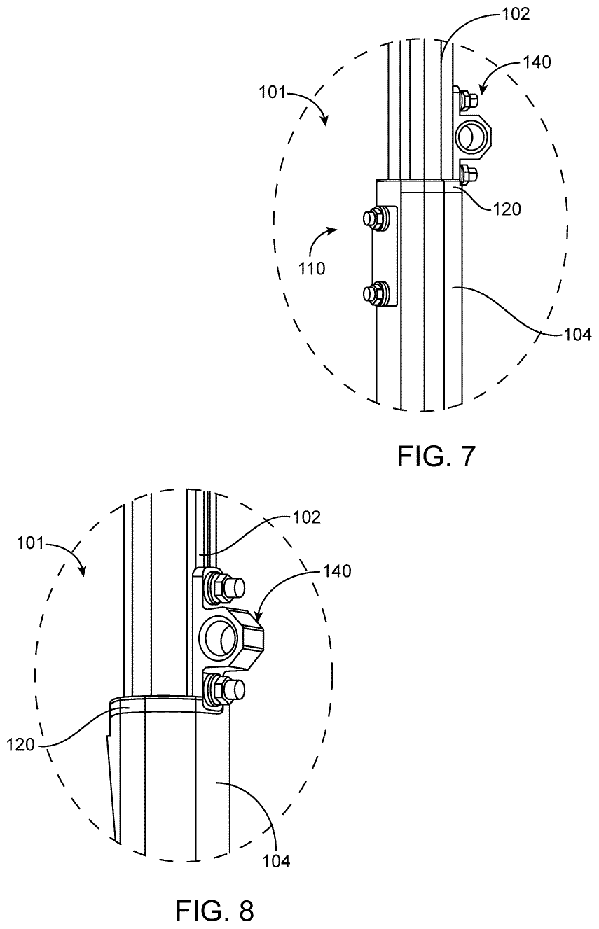

FIGS. 7 and 8 are perspective views of the locking mechanism 101 for locking the inner tubular member 102 to the outer tubular member 104. In a preferred embodiment, the locking mechanism 101 comprises a friction coupling assembly 110 and a positive stop assembly 140. The locking mechanism 101 is formed near the point at which the inner tubular member 102 enters the outer tubular member 104.

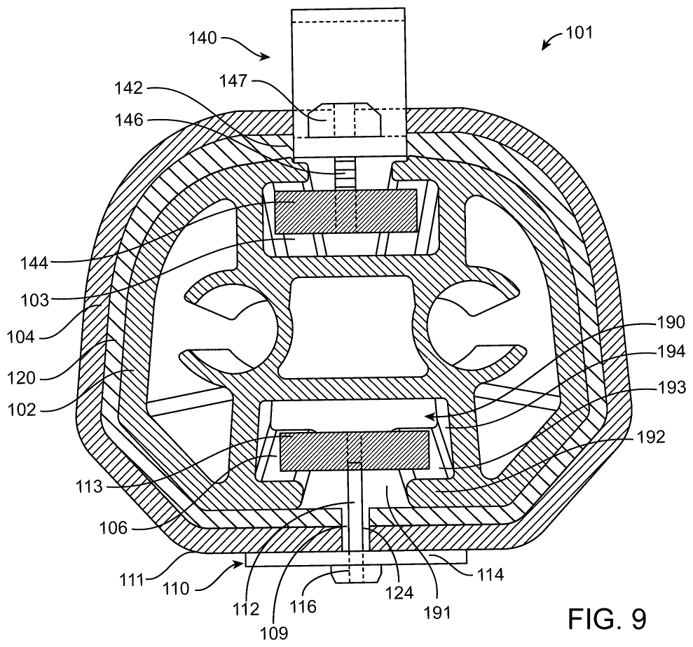

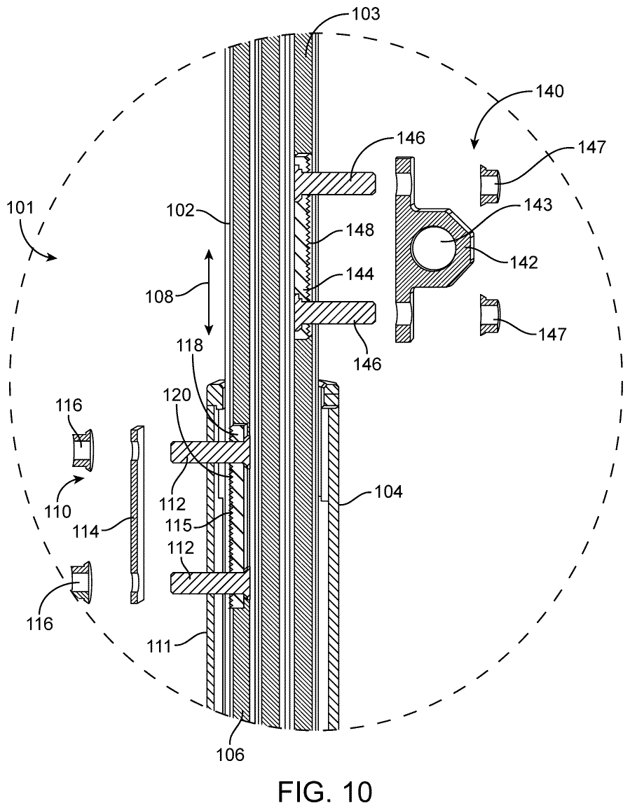

FIGS. 9 and 10 are cross-sectional views of the locking mechanisms 101 and the inner 102 and outer tubular members 104. Each telescoping upright 160abcd comprises an outer tubular member 104 and an inner tubular member 102. The outer tubular member 104 has an internal cavity 105 (see FIG. 14) adapted to slidably receive the inner tubular member 102. The inner tubular member 102 and the outer tubular member 104 are adapted to telescope longitudinally to vary an overall height of the pair of the telescoping uprights 160abcd over a continuous range. The inner tubular member 102 has a first T-shaped channel 106 and a second T-shaped channel 103 formed on the outer surface 107 of inner tubular member 102. The inner tubular member 102 and the outer tubular member 104 extends longitudinally 108 along the inner tubular member 102. Each telescoping upright 160abcd further comprises a locking mechanism 101 for releasably adjusting and locking the height “h” 161 (see FIG. 5) of each telescoping upright 160abcd.

As seen in FIG. 9, the inner tubular member 102 has a first T-shaped channel 106 and a second T-shaped channel 103 formed on the outer surface 107 of inner tubular member 102. In a preferred embodiment, the first 106 and second 103 T-shaped channels are formed on opposite sides of the inner tubular member 102. The T-shaped channels 103 and 106 (as well as the T-shaped channels 163 and 165 of the crossmembers 162 and 164) each have a top opening or mouth 191, flanges or shoulders 192, an inner wall 193 or the flange 192, and a throat 194.

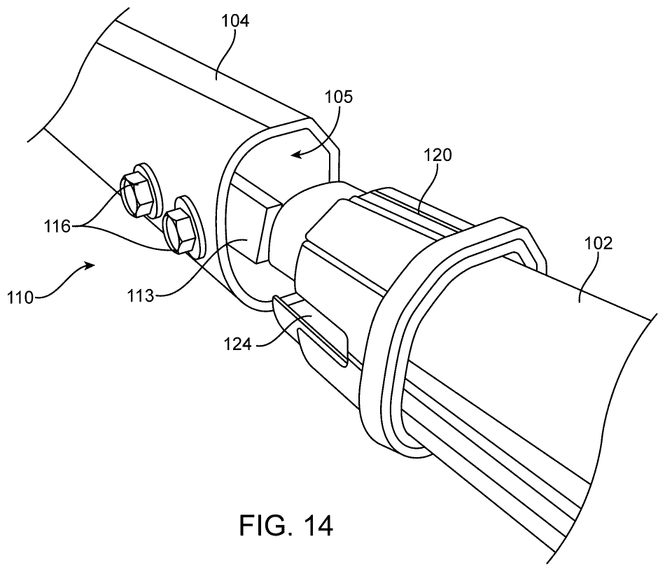

Between the inner tubular member 102 and the outer tubular member 104 is a frame 120 (i.e., “sleeve” 120, see also FIGS. 13 and 14). The sleeve 120 is axially positioned between the inner tubular member 102 and the outer tubular member 104 which aligns and centers the inner tubular member 102 within the outer tubular member 104. The sleeve 120 allows longitudinal movement 108 of the inner tubular member 102 within the outer tubular member 104. In a preferred embodiment, the sleeve is made of fiber impregnated ABS polymer.

Turning now to the discussion of the assemblies for locking the height of the uprights 160abcd, as shown in FIGS. 7 and 8, each upright 160abcd further comprises a locking mechanism 101 formed on the uprights proximal to the location of the point where the inner tubular member 102 enters the outer tubular member 104. The locking mechanism 101 comprises two assemblies: (1) a friction coupling assembly 110 and a (2) positive stop assembly 140. Both assemblies 110 and 140 rely on their own generally rectangular “slide plate” placed in T-shaped channels formed on the inner tubular member 102, where the slide plate is compressed against the T-shaped channel to releasably lock the slide plate in place.

The friction coupling assembly 110 effectively bolts the outer tubular member 104 to its slide plate so that the inner 102 and outer 104 tubular members are held in place via a frictional coupling.

The positive stop assembly 140 effectively bolts a projecting stop plate 142 to its slide plate locking the projecting stop plate 142 onto the inner tubular member 102. This projecting stop plate 142 interferes with the forward movement of the inner tubular member 102 and prevents it from further entering the outer tubular member 104.

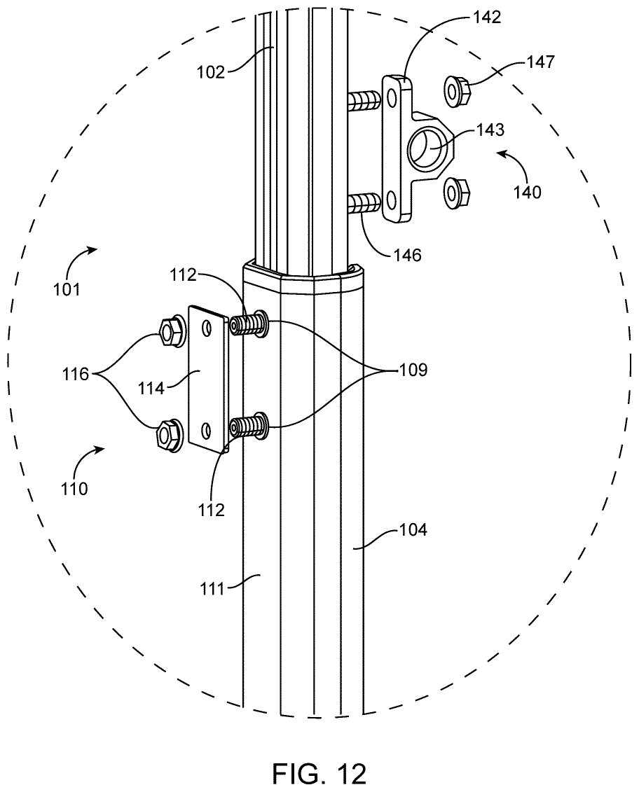

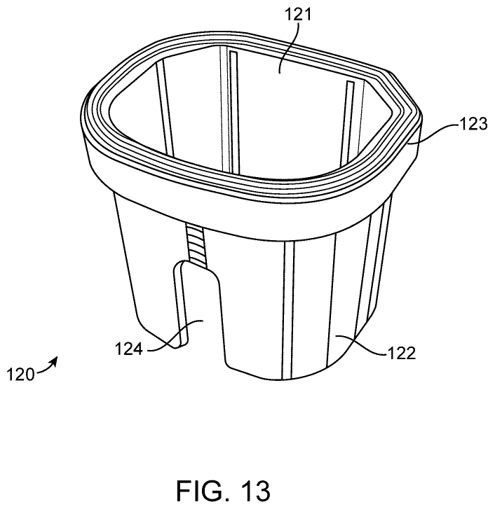

More specifically, the friction coupling assembly 110 can be understood by collectively viewing FIGS. 9, 10 and 12. The friction coupling assembly 110 comprises a generally rectangular friction coupling slide plate 113 configured to slide longitudinally 108 and engage within the first T-shaped channel 106 of the inner tubular member 102. The friction coupling assembly 110 further comprises two friction coupling threaded rods 112 emerging from the friction coupling slide plate 113 away from the inner tubular member 102. The two friction coupling threaded rods 112 extend through the sleeve 120 via the slot 124 slot on the sleeve 120, and further extends through the outer tubular member 102 via the holes 109 (see also FIG. 12) in the outer tubular member 102. The two friction coupling threaded rods 112 further extends through the friction coupling lock plate 114 positioned on an outer surface 111 of the outer tubular member 104 and then through to the two friction coupling threaded nuts 116 engaging with the two friction coupling threaded rods 112. The friction coupling lock plate 114 ties the entire friction coupling assembly 110 together structurally making it more difficult to slide the inner tubular 102 and outer tubular 104 members relative to one another when fully tightened.

The friction coupling assembly 110 operates as follows. When the nuts 116 are loose, the friction coupling slide plate 113 freely moves within the first T-shaped channel 106 of the inner tubular member 102, which allows the user to set the height h 161 of the uprights 160abcd. The sleeve 120 separates the inner tubular member 102 from the outer tubular member 104 so that the inner tubular member 102 moves freely.

The height h of the uprights 160abcd is then set by the user tightening the friction coupling threaded nuts 116. As the threaded nuts 116 are tightened, the nuts 116 engage with the threaded rods 112 which causes the friction coupling slide plate 113 to move toward and engage with the inner wall 193 of the flange 192 of the first T-shaped channel 106. The friction coupling slide plate 113 becomes frictionally coupled to the flange 192, which locks the height h of the uprights 160abcd so that the inner tubular member 102 is prevented from moving toward or away from the outer tubular member 104 when locked. In a preferred embodiment, the friction coupling slide plate is textured 115 or knurled to increase the frictional engagement with the first T-shaped channel 106.

In an embodiment, the friction coupling assembly 110 comprising a friction coupling slide plate 113 configured to slide and engage within the first T-shaped channel 106 of the inner tubular member 102. One or more friction coupling fasteners 112, such as threaded rods 112 engaging with nuts 116, emerges from the friction coupling slide plate 113 away from the inner tubular member 102 and extends through the outer tubular member 104, where the friction coupling assembly 110 locks a position of the inner tubular member 102 with respect to the outer tubular member 104. In an embodiment, the fasteners 112 may include a bolt entering the outer 104 and inner 106 tubular members to engage with threaded holes formed on the friction coupling slide plate 113. Other fasteners are contemplated in one or more embodiments such as employing toggle clamps, cam locks, and lever and cam mechanisms for example.

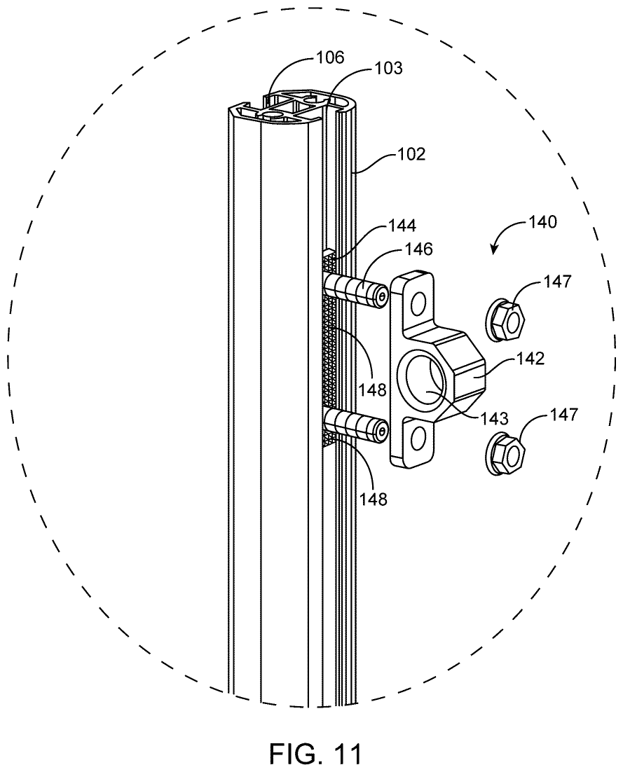

Likewise, the positive stop assembly 140 can be understood by collectively viewing FIGS. 9, 10, 11, and 12. The positive stop assembly 140 comprises a generally rectangular positive stop slide plate 144 configured to slide longitudinally 108 and engage within the second T-shaped channel 103 of the inner tubular member 102. The positive stop assembly 140 further comprises two friction coupling threaded rods 146 emerging from the positive stop slide plate 144 away from the inner tubular member 102. The two positive stop threaded rods 146 then engage with the positive stop plate 142 placed on the outer surface 107 of the inner tubular member 102. The positive stop threaded rods 146 further extends through the positive stop plate 142 to the positive stop threaded nuts 147 engaging with the two positive stop threaded rods 146. In a preferred embodiment, the positive stop plate 142 further comprises a tie down 143 for threading rope to secure cargo.

The positive stop assembly 140 operates as follows. When the nuts 147 are loose, the positive stop slide plate 144 freely moves within the second T-shaped channel 103 of the inner tubular member 102, which allows the user to set the height h 161 of the uprights 160abcd. The sleeve 120 separates the inner tubular member 102 from the outer tubular member 104 so that the inner tubular member 102 moves freely.

The height h of the uprights 160abcd is then set by the user tightening the positive stop threaded nuts 147. As the threaded nuts 147 are tightened, the nuts 147 engage with the threaded rods 146 which causes the positive stop slide plate 144 to move toward and engage with the inner wall 193 of the flange 192 of the second T-shaped channel 103. The positive stop slide plate 144 becomes frictionally coupled to the flange 192, which locks the position of the positive stop slide plate 144 on the inner tubular member 102. In a preferred embodiment, the positive stop slide plate 144 is textured 148 or knurled to increase the frictional engagement with the second T-shaped channel 103. As the inner tubular member 102 is pushed into the outer tubular member 104, the positive stop plate 144 then engages with the sleeve 120 and provides an affirmative stop preventing the inner tubular member 102 from extending further into the outer tubular member 104.

In an embodiment, the positive stop assembly 140 comprises a positive stop slide plate 144 configured to slide and engage within the second T-shaped channel 103 of the inner tubular member 102. One or more positive stop fasteners 146, such as threaded rods 146 engaging with nuts 147, emerge from the positive stop slide plate 144 away from the inner tubular member 102 and engages with a positive stop plate 142 placed on an outer surface 107 of the inner tubular member 102. A positive stop fastener 146 is adopted urge the positive stop slide plate 144 against the second T-shaped channel 103 creating a frictional engagement which locks a position of the positive stop slide plate 142 in the second T-shaped channel 103.

The positive stop assembly 140 locks a position of the positive stop plate 142 on the inner tubular member 102 creating an affirmative stop preventing the further movement of the outer tubular member 104 with respect to the inner tubular member 102. In an embodiment, the fasteners 146 may include a bolt entering the inner tubular member 102 to engage with threaded holes formed on the positive stop slide plate 144. Other fasteners are contemplated in one or more embodiments such as employing toggle clamps, cam locks, and lever and cam mechanisms for example.

FIG. 13 is a perspective view of a frame 120 (i.e., “sleeve 120”) having an inner aperture 121 for receiving an inner tubular member 102 and an outer surface 122 contoured for slipping into the outer tubular member. The sleeve 120 has a slot 124 for accommodating the threaded rods 112 of the friction coupling assembly.

The sleeve 120 is axially positioned between the inner tubular member 102 and the outer tubular member 104. The sleeve 120 aligns and centers the inner tubular member 102 within the outer tubular member 104. The sleeve 120 facilitates longitudinal movement of the inner tubular member 102 within the outer tubular member 104.

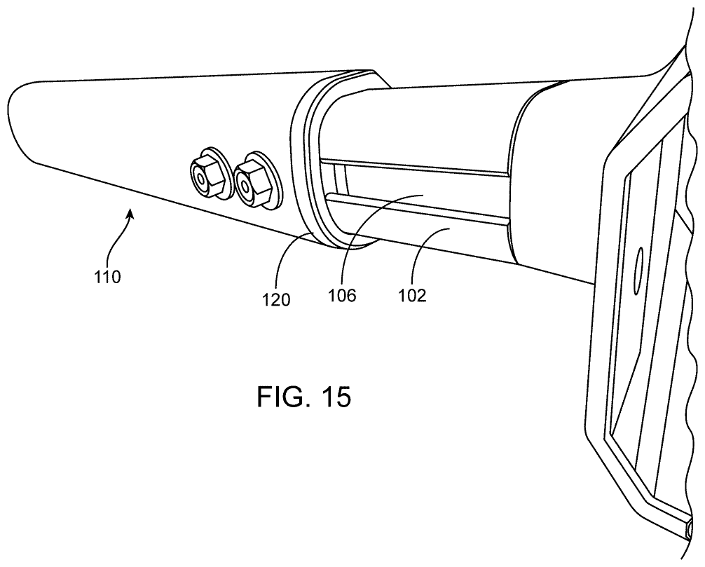

FIGS. 14 and 15 illustrate the process of assembling the inner tubular member 102, the outer tubular member 104, and the sleeve 120. As shown in FIG. 14, the nuts 116 are loosed on the friction coupling assembly 110 so that the friction coupling slide plate 113 is free to move within the inner tubular member 102. As shown in FIG. 15, the inner tubular member 102 is received within the outer tubular member 104 with the sleeve 120 set in place.

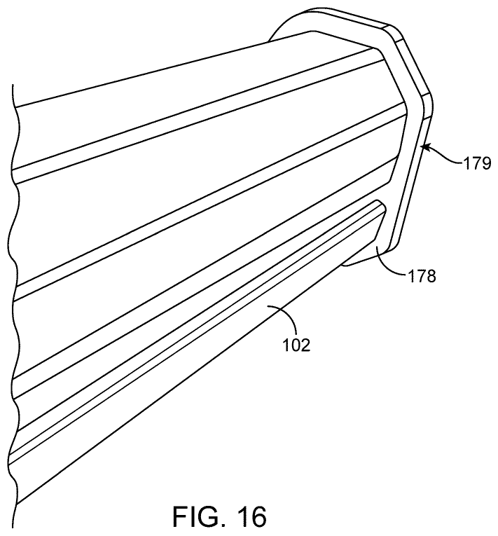

FIG. 16 is a perspective view of an inner tubular member 102 having an endcap 178. The endcap 178 has an outer surface 179 contoured to be received by the outer tubular member 104. The endcap 178, as well as the sleeve 120 shown in FIG. 13, serve to align and center the inner tubular member 102 within the outer tubular member 104.

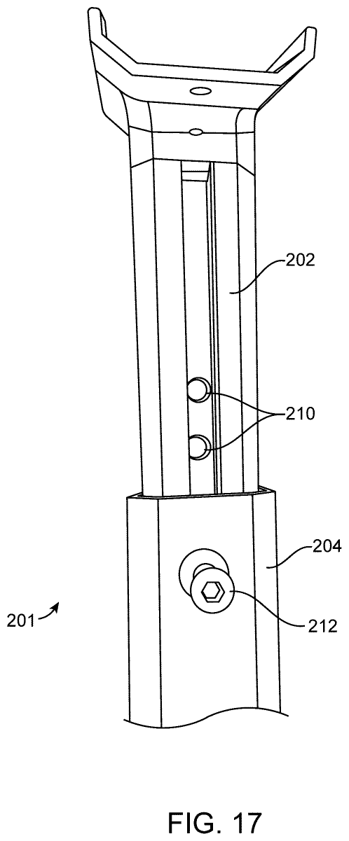

FIG. 17 is a side view of an upright 201 comprising an inner tubular member 202 received by an outer tubular member 204. The inner tubular member 204 has a series of indexed holes 210 placed along the length of the inner tubular member 202. A bolt 212 passes through the outer tubular member 204 and one of the holes 210, which is secured to fix the inner tubular member 102 in place with the outer tubular member 204.

As discussed above, the truck rack 100 described herein may be configured to serve as either a “contractor rack” for use by tradesmen and contractors who carry construction equipment and supplies to their jobsites, or as an “overland rack” for carrying camping equipment, kayaks, and bicycles. In a preferred embodiment, the truck rack 100 may be readily assembled as in either a “contractor rack” configuration or an “overland rack” configuration. Moreover, the truck rack 100 may also be quickly and conveniently converted between a “contractor rack” configuration and the “overland rack” configuration without tools or having to disassemble the truck rack 100.

Referring back to FIG. 3, a contractor rack 130 may comprise the mounts 180abcd, the uprights 160abcd, and the crossmembers 162, 164, and 166. In this configuration, the contractor rack 130 may be better suited for carrying dimensional lumber and other construction supplies, for example.

An overland rack assembly 132 expands upon the contractor rack 130 and may comprise the lower side rails 168ab, the upper side rails 170ab, the drop hoop 176, and the support members 174abcd, as well as the over cab coupling mechanisms 150abcd which connect the lower side rails 168ab of the overland rack assembly to the crossmembers 162 and 164 of the contractor rack 130. The overland rack assembly 132, having side rails 168ab and 170ab, may be better suited for bulkier items such as camping equipment. Moreover, the drop hoop 176 over the truck cab 14, being formed in the same plane as the upper surfaces of crossmembers 168a and 168b, may enable longer items such as kayaks and surfboards to be stowed.

There are at least two benefits associated with the design of the truck rack 100. First, the overland rack assembly 132, once assembled, can remain a combined structure and stay intact as an integrated unit semi-permanently (until the overland rack assembly 132 needs to be modified). Hence, for example, a user may construct the truck rack 100 as a “contractor rack” by assembling the contractor rack 130 onto their truck 10. When the user wishes to use the truck rack 100 for other purposes such as to go camping, the user may then convert the truck rack 100 into an “overland rack” by placing the assembled overland rack assembly 132 onto the contractor rack 130. Upon returning from camping, the user may remove the intact, overland rack assembly 132 from the contractor rack 130.

Second, the over cab coupling mechanisms 150abcd provide a quick disconnect for conveniently converting between a “contractor rack” and an “overland rack.” As discussed in greater detail below, the over cab coupling mechanisms 150abcd connect the lower side rails 168ab to the crossmembers 162 and 164. A knurled knob 155 on the over cab coupling mechanisms 150abcd, when loosened, releases the over cab coupling mechanisms 150abcd from the crossmembers 162 and 164. Once the knurled knob 155 is fully loosened, the user may remove and set aside the intact overland rack assembly 132 from the crossmembers 162 and 164, leaving a “contractor rack” on the truck 10.

Turning now to discuss the over cab coupling mechanisms, as shown in FIG. 3, four over cab coupling mechanisms 150abcd are adopted for releasably securing the lower siderails 168ab to the crossmembers 162 and 164. The crossmember 162 has a crossmember T-shaped channel 163, and the crossmember 164 has a crossmember T-shaped channel 165.

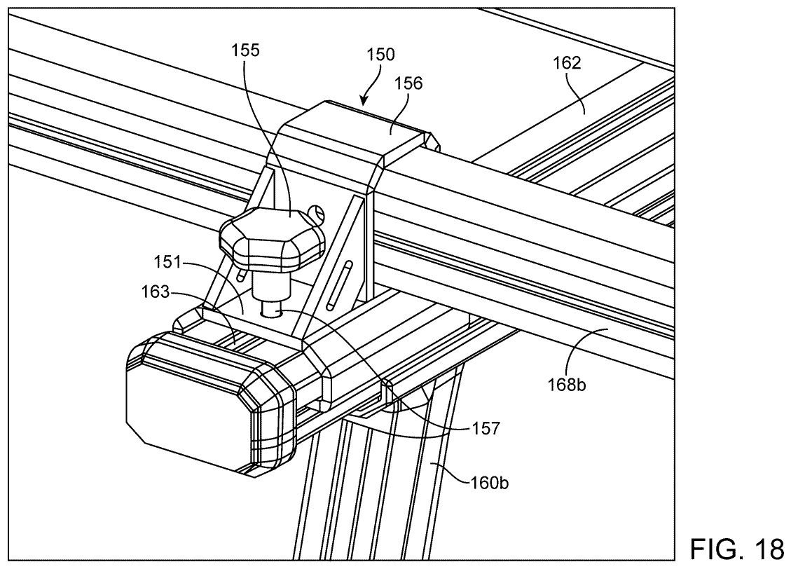

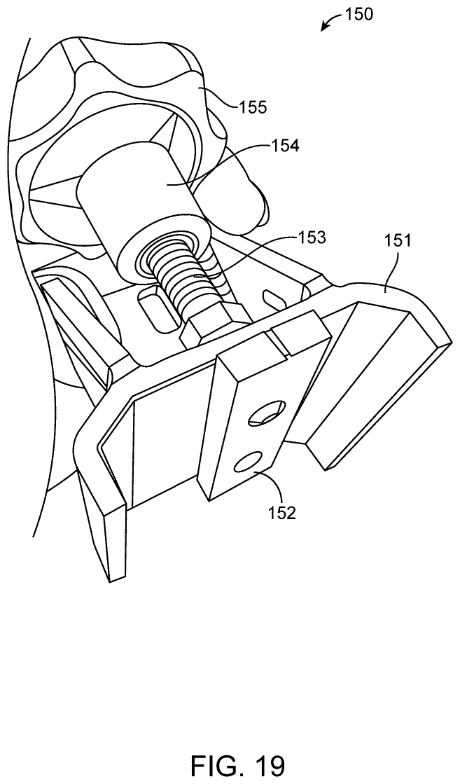

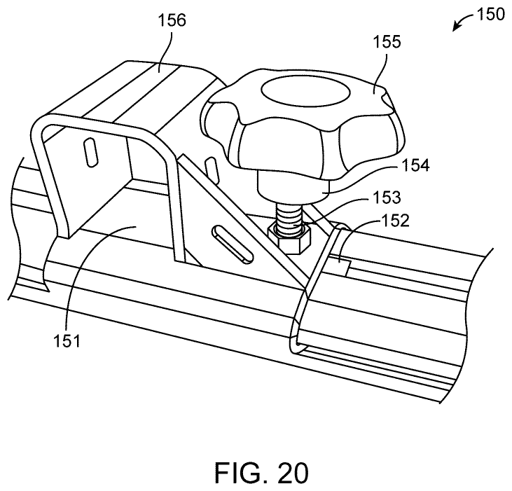

FIG. 18-20 illustrate the “over cab coupling mechanism 150” employed to couple crossmembers (e.g., crossmember 162 as shown) to the lower slide rails (e.g., lower siderail 168b as shown). The over cab coupling mechanism 150 comprises a generally rectangular over cab slide plate 152 configured to slide within and engage with the crossmember T-shaped channel 163 of the crossmember 162. An over cab threaded rod 153 emerges from the over cab slide plate 152 away from the crossmember 162. In a present preferred embodiment, a base plate 151 is countered to at least partially surround and slide upon the crossmember 162. The base plate may comprise a flat generally rectangular structure in an embodiment. The base plate 151 has an over cab through hole 157 to receive the over cab threaded rod 153. The over cab threaded nut 154 engages with the over cab threaded rod 153, wherein tightening the over cab threaded nut 154 locks the position of the over cab mechanism 150 on the crossmember 162. A knurled knob 155 attached to the nut 154 allows a user to effectively hand-tighten the over cab coupling mechanism 150 in place. The over cab coupling mechanism 150 further comprises an open sleeve 156 formed on the base plate, the open sleeve adapted for receiving a side rail 168. Hence, the lower side rail 168 may be moved longitudinally along the length of the crossmember 162, and lock in place by tightening the knurled knob 155.

Although the invention has been discussed with reference to specific embodiments, it is apparent and should be understood that the concept can be otherwise embodied to achieve the advantages discussed. The preferred embodiments above have been described primarily as a robust truck rack with continuously adjustable components. In this regard, the foregoing description of the truck rack is presented for purposes of illustration and description. It shall be apparent that other types of equipment would benefit from the aspects of the continuously adjustable truck rack.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A truck rack for a truck bed, the truck rack comprising:
a crossmember having a crossmember T-shaped channel formed on the outer surface thereof extending longitudinally along the crossmember;
a pair of telescoping uprights extending upward from opposite sides of the truck bed supporting the crossmember, each telescoping upright comprising an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, each telescoping upright further comprising a locking mechanism for releasably adjusting and locking the height of each telescoping upright, each locking mechanism comprising:
a friction coupling assembly comprising:
a friction coupling slide plate configured to slide and engage within the first T-shaped channel of the inner tubular member;
one or more friction coupling fasteners emerging from the friction coupling slide plate away from the inner tubular member and extending through the outer tubular member,
wherein the friction coupling assembly locks a position of the inner tubular member with respect to the outer tubular member; and,
a positive stop assembly comprising:
a positive stop slide plate configured to slide and engage within the second T-shaped channel of the inner tubular member;
one or more positive stop fasteners emerging from the positive stop slide plate away from the inner tubular member; and,
a positive stop plate placed on an outer surface of the inner tubular member and engaging with the one or more positive stop fasteners, the positive stop fasteners releasably positioning the positive stop plate on the inner tubular member to provide an affirmative stop preventing further movement of the inner tubular member into the outer tubular member.

2. The truck rack for a truck bed of claim 1, further comprising:
an over cab coupling mechanism comprising:
an over cab slide plate configured to slide and engage within a crossmember T-shaped channel of the crossmember;
one or more over cab fasteners emerging from the over cab slide plate away from the cross member;
a base plate countered to at least partially surround and slide upon the crossmember, the base plate engaging with the one or more over cab fasteners, the over cab coupling mechanism adopted to lock a position of the over cab mechanism on the crossmember; and,
an open sleeve formed on the base plate, the open sleeve adapted for receiving a side rail.

3. The truck rack for a truck bed of claim 2, wherein one or more of the friction coupling slide plate, the positive stop slide plate, and the over cab slide plate are textured.

4. The truck rack for a truck bed of claim 2, wherein the one or more over cab fasteners comprise one or more bolts having a knurled knob adopted for hand tightening such that the over cab slide plate is locked in position.

5. The truck rack for a truck bed of claim 1, the friction coupling assembly further comprising a friction coupling lock plate positioned on an outer surface of the outer tubular member and engaging with the one or more friction coupling fasteners.

6. The truck rack for a truck bed of claim 1, further comprising a sleeve axially positioned between the inner tubular member and the outer tubular member, the sleeve aligning and centering the inner tubular member within the outer tubular member, the sleeve allowing longitudinal movement of the inner tubular member within the outer tubular member.

7. The truck rack for a truck bed of claim 1, wherein each telescoping upright supports at least 200 pounds of weight.

8. The truck rack for a truck bed of claim 1, wherein the inner tubular member and the outer tubular members are formed in extruded aluminum.

9. The truck rack for a truck bed of claim 1, wherein the positive stop plate further comprises a tie down.

10. A truck rack for a truck bed, the truck rack comprising:
a pair of telescoping uprights extending upward from opposite sides of the truck bed supporting a crossmember, each telescoping upright comprising an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, each telescoping upright further comprising a locking mechanism for releasably adjusting and locking the height of each telescoping upright, each locking mechanism comprising:
a friction coupling assembly comprising:
a friction coupling slide plate configured to slide and engage within the first T-shaped channel of the inner tubular member, the friction coupling slide plate attached to a fixed position on the outer tubular member;
a fastener adopted urge the friction coupling slide plate against the first T-shaped channel creating a frictional engagement which locks a position of the friction coupling slide plate in the first T-shaped channel, thereby locking a position of the inner tubular member with respect to the outer tubular member; and,
a positive stop assembly comprising:
a positive stop slide plate configured to slide and engage within the second T-shaped channel of the inner tubular member;
a positive stop plate placed on an outer surface of the inner tubular member, the positive stop plate attached to the positive stop slide plate; a positive stop coupling mechanism adopted urge the positive stop slide plate against the second T-shaped channel creating a frictional engagement which locks a position of the positive stop slide plate in the second T-shaped channel; and,
wherein the positive stop assembly locks a position of the positive stop plate on the inner tubular member creating an affirmative stop preventing the further movement of the outer tubular member with respect to the inner tubular member.

11. The truck rack for a truck bed of claim 10, further comprising:
an over cab coupling assembly comprising:
an over cab slide plate configured to slide and engage within a crossmember T-shaped channel of a crossmember;
a base plate countered to at least partially surround and slide longitudinally along the crossmember, the base plate attached to the over cab slide plate;
an open sleeve formed on the base plate, the open sleeve adapted for receiving a side rail;
a friction coupling mechanism adopted to urge the over cab slide plate against the first a crossmember T-shaped channel creating a frictional engagement which locks a position of the over cab slide plate in the crossmember T-shaped channel, thereby locking a position of the base plate with respect to the crossmember.

12. The truck rack for a truck bed of claim 11, wherein the friction coupling mechanism comprises a bolt having a knurled knob adopted for hand tightening such that the over cab slide plate is locked in position within a crossmember T-shaped channel of a crossmember.

13. The truck rack for a truck bed of claim 11, wherein one or mor of the friction coupling slide plate, the positive stop slide plate, and the over cab slide plate are textured.

14. The truck rack for a truck bed of claim 10, further comprising a sleeve axially positioned between the inner tubular member and the outer tubular member, the sleeve aligning and centering the inner tubular member within the outer tubular member, the sleeve allowing longitudinal movement of the inner tubular member within the outer tubular member.

15. The truck rack for a truck bed of claim 10, wherein the inner tubular member and the outer tubular members are formed in extruded aluminum.

16. A truck rack for a truck bed, the truck rack comprising:
a front crossmember positioned near a front side of a truck bed, the front crossmember having a front T-shaped channel extending along the length of the front crossmember;
a back crossmember positioned near a back side of a truck bed, the back crossmember having a back T-shaped channel extending along the length of back crossmember;
an over cab assembly comprising a left side rail and a right side rail, the over cab assembly supported by the front and back crossmembers;
a first pair of telescoping uprights extending upward from opposite sides of the front of the truck bed supporting the front crossmember,
a second pair of telescoping uprights extending upward from opposite side of the back of the truck bed supporting the back crossmember
wherein:
each telescoping upright comprises an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, the outer tubular member comprising two friction coupling assembly mounting through holes;
each telescoping upright further comprises a locking mechanism for releasably securing and varying the height of each telescoping upright over a continuous range, each locking mechanism comprising:
a friction coupling assembly comprising:
a friction coupling slide plate configured to slide and engage within the first T-shaped channel of the inner tubular member;
two friction coupling threaded rods emerging from the friction coupling slide plate away from the inner tubular member and extending through the two friction coupling assembly mounting through holes of the outer tubular member;
a friction coupling lock plate positioned on an outer surface of the outer tubular member and engaging with the two friction coupling threaded rods; and,
two friction coupling threaded nuts engaging with the two friction coupling threaded rods, wherein tightening the friction coupling threaded nuts locks a position of the inner tubular member with respect to the outer tubular member; and,
a positive stop assembly comprising:
a positive stop slide plate configured to slide and engage within the second T-shaped channel of the inner tubular member;
two positive stop threaded rods emerging from the positive stop slide plate away from the inner tubular member;
a positive stop plate placed on an outer surface of the inner tubular member and engaging with the two positive stop threaded rods; and,
two positive stop threaded nuts engaging with the positive stop threaded rods, wherein tightening the positive stop threaded nuts locks a position of the positive stop plate on the inner tubular and provides an affirmative stop preventing further movement of the inner tubular member into the outer tubular member.

17. The truck rack for a truck bed of claim 16, further comprising:
four over cab coupling mechanisms adopted for releasably securing the over cab assembly to the front and back crossmembers, each over cab coupling mechanism comprising:
an over cab slide plate configured to slide and engage within the crossmember T-shaped channel of the crossmember;
one over cab threaded rod emerging from the over cab slide plate away from the cross member;
a base plate countered to at least partially surround a and slide upon the crossmember, the base plate having an over cab through hole to receive with the over cab threaded rod,
an over cab threaded nut engaging with the over cab threaded rod, wherein tightening the over cab threaded nut locks the position of the over cab mechanism on the crossmember; and,
an open sleeve formed on the base plate, the open sleeve adapted for receiving a side rail.

18. The truck rack for a truck bed of claim 17, wherein one or more of the friction coupling slide plate, the positive stop slide plate, and the over cab slide plate are textured.

19. The truck rack for a truck bed of claim 16, wherein the positive stop plate further comprises a tie down.

20. The truck rack for a truck bed of claim 16, wherein the inner tubular member and the outer tubular members are formed in extruded aluminum.

21. A truck rack for a truck bed, the truck rack comprising:
a contractor rack comprising:
a front crossmember positioned near a front side of a truck bed, the front crossmember having a front T-shaped channel extending along the length of the front crossmember;
a back crossmember positioned near a back side of a truck bed, the back crossmember having a back T-shaped channel extending along the length of back crossmember;
a first pair of telescoping uprights extending upward from opposite sides of the front of the truck bed supporting the front crossmember,
a second pair of telescoping uprights extending upward from opposite side of the back of the truck bed supporting the back crossmember;
an overland rack assembly comprising:
a lower pair of side rails; and,
four over cab coupling mechanisms connecting the lower pair of side rails of the overland rack assembly to the front and back crossmembers of the contractor rack;
wherein:
each telescoping upright comprises an outer tubular member and an inner tubular member, the outer tubular member having an internal cavity adapted to slidably receive the inner tubular member, the inner tubular member and the outer tubular member adapted to telescope longitudinally to vary an overall height of the pair of the telescoping uprights over a continuous range, the inner tubular member having a first and a second T-shaped channel formed on the outer surface thereof and extending longitudinally along the inner tubular member, the outer tubular member comprising two friction coupling assembly mounting through holes;
each telescoping upright further comprises a locking mechanism for releasably securing and varying the height of each telescoping upright over a continuous range, each locking mechanism comprising:
a friction coupling assembly comprising:
a friction coupling slide plate configured to slide and engage within the first T-shaped channel of the inner tubular member;
two friction coupling threaded rods emerging from the friction coupling slide plate away from the inner tubular member and extending through the two friction coupling assembly mounting through holes of the outer tubular member; and,
a friction coupling lock plate positioned on an outer surface of the outer tubular member and engaging with the two friction coupling threaded rods;
two friction coupling threaded nuts engaging with the two friction coupling threaded rods, wherein tightening the friction coupling threaded nuts locks a position of the inner tubular member with respect to the outer tubular member; and,
a positive stop assembly comprising:
a positive stop slide plate configured to slide and engage within the second T-shaped channel of the inner tubular member;
two positive stop threaded rods emerging from the positive stop slide plate away from the inner tubular member; and,
a positive stop plate placed on an outer surface of the inner tubular member and engaging with the two positive stop threaded rods; and,
two positive stop threaded nuts engaging with the positive stop threaded rods, wherein tightening the positive stop threaded nuts locks a position of the positive stop plate on the inner tubular and provides an affirmative stop preventing further movement of the inner tubular member into the outer tubular member.

22. The truck rack for a truck bed of claim 21, wherein each over cab coupling mechanism comprises:
an over cab slide plate configured to slide and engage within a crossmember T-shaped channel of a crossmember;
one over cab threaded rod emerging from the over cab slide plate away from the crossmember;
a base plate countered to at least partially surround a and slide upon the crossmember, the base plate having an over cab through hole to receive with the over cab threaded rod,
an over cab threaded nut engaging with the over cab threaded rod, wherein tightening the over cab threaded nut locks the position of the over cab mechanism on the crossmember; and,
an open sleeve formed on the base plate, the open sleeve adapted for receiving a side rail.

23. The truck rack for a truck bed of claim 22, wherein the overland rack assembly is configured to remain as a complete, intact assembly once assembled.

24. The truck rack for a truck bed of claim 22, wherein the overland rack assembly is releasably detachable from the contractor rack.
